(19) United States
(12) Patent Application Publication
(10) Pub. No.: US 2012/0125599 A1
(43) Pub. Date: May 24, 2012

(54) Artificial Simultaneous Production And Maintenance System Assisted By Mechanical Pumping With Flexible Tubing For Fluid Extraction

(75) Inventor: William Anthony Hammond Bravo, Mexico City (MX)

(73) Assignee: Avantub, S.A. de C.V., Reynosa (MX)

(21) Appl. No.: 13/297,990

(22) Filed: Nov. 16, 2011

(30) Foreign Application Priority Data
Nov. 19, 2010 (MX) MX/A/2010/012619

(51) Int. Cl. E21B 43/00; B23Q 17/00

(52) U.S. Cl. 166/105; 29/407.01

(57) ABSTRACT

An artificial simultaneous production and maintenance system assisted by mechanical pumping for fluid extraction, comprising: a surface assembly including a sub-base, a hydraulic drive head, a stuffing box, an O-ring preventer, a wedge preventer and a connection and splicing means; from the surface assembly a production tubing extends vertically downwards inside the well bore; a casing; a flexible tubing located inside the production tubing all along its length, being the casing, the production tubing and the flexible tubing concentrically one inside the other; and a pump assembly including a connector, a check valve, cleaning tool and a plunder pump. The system allows assisted production by mechanical pumping for fluid extraction and maintenance by simultaneous pumping of chemicals to the well to modify physical properties of the fluid to be extracted and clean organic and inorganic material buildup within the well.

### CROSS-REFERENCE TO RELATED APPLICATION AND INCORPORATION BY REFERENCE

This application claims the benefit of Mexican Patent Application No. MX/a/2010/012619, filed on Nov. 19, 2010, for “Artificial Simultaneous Production and Maintenance System Assisted by Mechanical Pumping for Fluid Extraction,” and incorporates the subject matter of the same by reference.

### FIELD OF THE INVENTION

The present invention is related to a system for fluid extraction from an oil well lacking of sufficient oilfield energy to lift the produced fluids to the surface. In particular, it is related to an artificial production system assisted by mechanical pumping with flexible tubing for fluid extraction, and maintenance by simultaneous pumping of chemicals into said oil well to modify the physical properties of the fluid to be extracted and to remove organic and inorganic matter deposited in the oil well.

### BACKGROUND OF THE INVENTION

Oil is extracted by drilling a well on an oil field. A sufficient oil pressure will force the oil to flow out naturally for its subsequent processing and/or distillation. However, if there is not sufficient pressure for the oil to flow to the surface and to maintain the production, a sucker rod pump (also known as pump jack, horsehead pump, beam pump, sucker rod pump, etc.) system is used. This pump is the superficial part of a piston impellent pump.

The sucker rod pump systems are common in oilfield extraction and their size is determined by deepness, inner diameter of tubing inside the well and density or viscosity of the oil to be extracted, where a deeper extraction requires more energy to move greater lengths of fluid column. A rod-crank mechanism converts the engine's rotary movement into an alternate vertical movement that moves the rod of the pump producing a reiterative up-down movement.

Rod pumps are actuated by an engine. Said engine moves a pulley system which in turn is connected to a connecting rod to compensate the weight of the rod string reaching the bottom of the well. The connecting rod moves up and down a crank connected to a beam's end; the other end of the beam has a head. A steel cable connects the head with the polished rod that goes through a sealing box, permitting the movement inside and outside the tubing but not allowing the fluid to escape from the well (the tubing runs until the bottom of the well). On the bottom of the well there is a reciprocating pump, which has two valves: a static valve and a valve on the piston connected to the end of the rods with a superior-inferior path, known as the “traveling valve.”

Once the sucker rod pump systems are installed, the production continues until problems appear, typically on the bottom of the well, with the deposit of substances like carbonates, paraffin, asphaltenes, sand, formation and corrosion residues, and the like.

Due to the deposit of the above mentioned substances, the standing and traveling valve seats begin to wear out; as well as the spaces between the traveling container and the polished wall of exterior tubing of the reciprocating pump, causing lack of seal and failure to efficiently lift the oil to the surface; or even they get stuck preventing their proper operation. Likewise, the existing gas within the reservoir may lead to cavitations that hinder the pump, where due to the high gas compressibility, the build-up pressure is not sufficient to open the valves and little or nothing is pumped.

When this happens it is necessary to remove all the equipment from subsurface to the surface in order to repair or replace it. This operation is performed with rod equipment consisting of a rig with a winch with sufficient capacity to load all rods in the well. Extraction, substitution and introduction operation is performed in a 2 to 24 hours period, depending on the well's deepness. Then, it is convenient to clean the bottom of the well between each extraction-introduction in order to prevent any damage occur more frequently. Oil well cleaning needs from one to seven days according to the equipment used for cleaning (reparation equipment, line equipment or flexible tubing equipment); this implies costly operations and production loss for a long time.

Prior art typically discloses information about cleaning oil wells, as the U.S. Pat. No. 5,095,976, that brings protection to a cleaning equipment by means of an inner tubing and reciprocating elements.

Document U.S. Pat. No. 7,475,731 discloses an apparatus and method to clean an oil well by means of fluid injection and subsequent sediment suction.

The use of an apparatus to clean oil wells comprising a tubular conveyor extending from surface to the well portion to be cleaned by means of pumps on the bottom of the hole is known from document EP 1852571.

In addition to oil-well cleaning systems and/or methods included in prior art, there are documents protecting systems for a more efficient production of wells by sucker rod pumping, however those systems are susceptible to substance build-up causing lack of seal and consequently it is necessary to disassemble the entire equipment for replacement or maintenance.

A proper pumping system of dual displacement for fluid production of an oil well is described in document U.S. Pat. No. 6,585,049. This document discloses a pump and a dual displacement pumping system, wherein the system includes a subsurface pump, a production tubing column, a surface pumping unit connected to the subsurface pump by means transmitting reciprocating movements. Said document includes the presence of a production tubing column and has a production inside itself and in its annular portion, i.e. the intubation column. As in hydrocarbon extraction systems that include inner tubing in the intubation column, the system of U.S. Pat. No. '049 necessarily requires disassembling and separating the elements of surface and subsurface structure for preventive, predictive or corrective maintenance, that become into production losses.

The system described by U.S. Pat. No. 6,502,639 provides an improved pumping system including a subsurface pump, a tubing column and a surface pumping unit.

Subsurface pump is attached in the well and driven by the tube up and down repetitive movements. Subsurface pump pumps liquids to the surface through the intubation column. This patent describes a system using a tube to “move” a reciprocating pump; however, the system is exclusive for oil extraction and in case of failure or breakdown hindering functions, all the equipment must be disassembled, including that in the subsurface, to be repaired. In addition, the system extracts oil exclusively through concentric tubing leaving free the intubation column.

Thus, the state of the art does not mention a mechanical pumping system with flexible tubing for simultaneous extraction and cleaning of a well, making more efficient the productive process preventing expenses for repair or maintenance.

### OBJECTS OF THE INVENTION

An object of the present invention is to provide an artificial simultaneous production and maintenance system assisted by mechanical pumping with flexible tubing for fluid extraction of a well, and simultaneous cleaning of said well.

Another object of the present invention is to provide an artificial production and maintenance system assisted by mechanical pumping with flexible tubing for fluid extraction of a well where said well does not have the necessary reservoir power to lift the produced fluids to the surface.

A further object of the present invention is to provide an artificial simultaneous production and maintenance system assisted by mechanical pumping with flexible tubing for fluid extraction, wherein the internal tubing is flexible.

A further object of the present invention is to provide an artificial production and maintenance system assisted by mechanical pumping with flexible tubing for fluid extraction, which makes maintenance and cleaning of the well without having to disassembling the extraction equipment and fixtures from subsurface or surface.

Another object of the present invention is to provide an artificial simultaneous production and maintenance system assisted by mechanical pumping with flexible tubing for fluid extraction, which reduces logistic and installation costs for being of easy maneuverability.

A further object of the present invention is to provide an artificial simultaneous production and maintenance system assisted by mechanical pumping with flexible tubing for fluid extraction that substitutes the steel bars or rods for flexible tubing that admits fluid circulation and allows coupling with a traveling valve.

Yet another object of the present invention is to provide an artificial simultaneous production and maintenance system assisted by mechanical pumping with flexible tubing for fluid extraction, wherein the flexible tubing admits injection of chemical fluids for cleaning, descaling the tubing, removing sand from the well and production system and reducing viscosity.

A further object of the present invention is to provide an artificial simultaneous production and maintenance system assisted by mechanical pumping with flexible tubing for fluid extraction, in which the production is obtained through production tubing in its annular space with the flexible tubing.

Yet another object of the present invention is to provide an artificial simultaneous production and maintenance system assisted by mechanical pumping with flexible tubing for fluid extraction, wherein the flexible tubing admits injection of chemical fluids to clean the wellbore.

A further object of the present invention is to provide an artificial simultaneous production and maintenance system assisted by mechanical pumping with flexible tubing for fluid extraction, which allows pumping fluids from the surface inside or through the flexible tubing to make efficient cleaning and external displacement, outside the flexible tubing, to reach an optimum speed in annular area for cleaning and production of hydrocarbons.

### BRIEF DESCRIPTION OF THE DRAWINGS

The invention will be described in more detail according to the appended figures, wherein:

FIG. 1 shows a front view of an artificial simultaneous production and maintenance system assisted by mechanical pumping with flexible tubing for fluid extraction.

FIG. 2 shows a front view of a bottom assembly forming part of the artificial simultaneous production and maintenance system assisted by mechanical pumping with flexible tubing for fluid extraction.

FIG. 3 shows a front view of a surface assembly forming part of the artificial simultaneous production and maintenance system assisted by mechanical pumping with flexible tubing for fluid extraction.

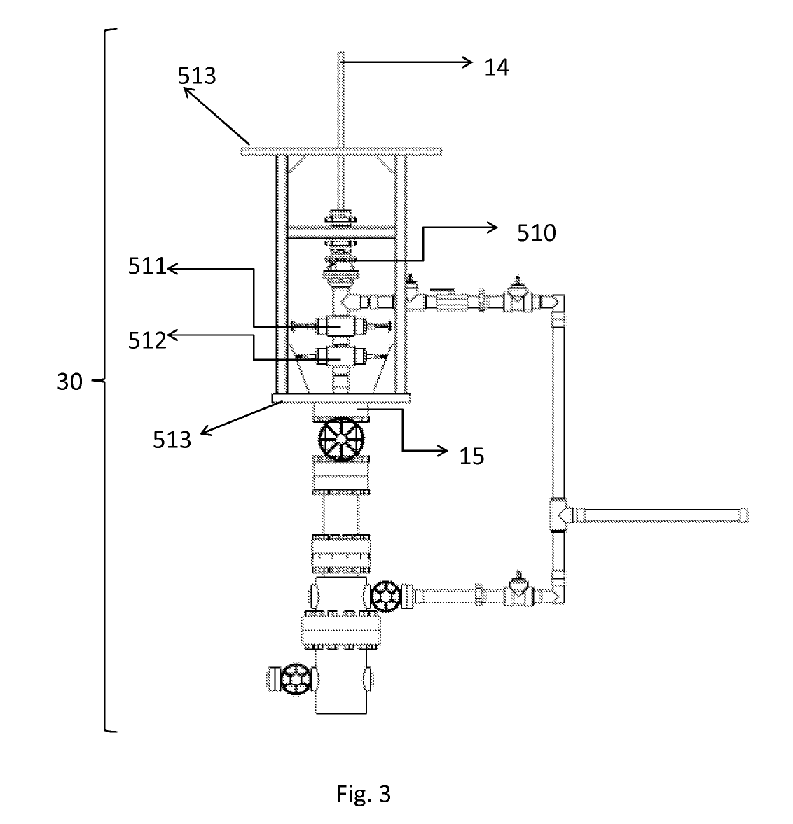

FIG. 4 shows a schematic view of the flow of the chemical or chemical fluid of the artificial simultaneous production and maintenance system assisted by mechanical pumping with flexible tubing for simultaneous fluid extraction and cleaning of a well.

FIG. 5 shows a schematic view of the flow of the production fluid of the artificial simultaneous production and maintenance system assisted by mechanical pumping with flexible tubing for fluid extraction.

FIG. 6 shows a front view of the hydraulic drive head assembly forming part of the artificial simultaneous production and maintenance system assisted by mechanical pumping with flexible tubing for fluid extraction.

Next a list of technical elements of the invention is shown:

### LIST OF TECHNICAL ELEMENTS OF THE INVENTION

artificial simultaneous production and maintenance system assisted by mechanical pumping with flexible tubing for fluid extraction (100)
reservoir (11)
well (10)
well casing (12)
surface assembly (30)
connection and splicing means (15)
production tubing (16)
flexible tubing (14)
connector (17)
pumping assembly (19)
shoe connector (197)
check valve (192)
cleaning tool (194)
circulation ports (1941)
blind connection (195)
production holes (200)
annular space (20)
plunger pump (21)
discharge piping (201)
hydraulic drive head system (50)
hydraulic connection (501)
hydraulic pistons (502)
pulleys (503)
pump connection type 1502 (504)
guide car (505)
clamp (506)
high pressure connector (507)
traveling hydraulic connector (508)
pumping hose (509)
stuffing box system (510)
O-ring preventer (511)
wedge preventer (512)
sub-base (513)
steel cable (514)
head structure (515)
stroke sensor (516)
stationary hydraulic connector (517)
pumping pipe (518)

### DETAILED DESCRIPTION OF THE INVENTION

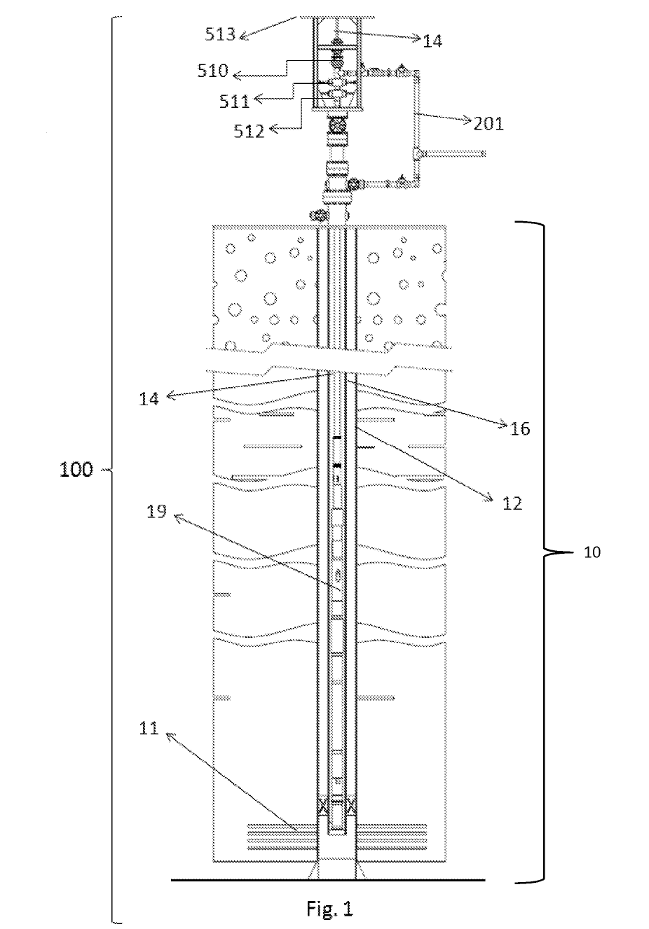

With reference to the appended drawings, particularly FIG. 1 illustrates an artificial simultaneous production and maintenance systems assisted by mechanical pumping with flexible tubing for fluid extraction 100. FIG. 1 shows a well 10 extending from the soil surface through the ground to connect with the reservoir 11.

Oil or hydrocarbon of the reservoir 11 is extracted through the well 10. The artificial simultaneous production and maintenance system 100 of the present invention is installed inside the well 10. This system includes a casing 12 extending across the well 10 from the surface up to the reservoir 11.

The artificial simultaneous production and maintenance system assisted by mechanical pumping with flexible tubing for fluid extraction 100 of the present invention works along with equipment mounted on the well surface by means of a surface assembly 30 which for that purpose includes a sub-base 513 and an hydraulic drive head 50. The equipment forms part of the state of the art and it is responsible of supporting the weight of the tubing for fluid circulation to the surface and downhole.

The surface assembly 30 that forms part of the artificial simultaneous production and maintenance system assisted by mechanical pumping with flexible tubing for fluid extraction 100 includes: a stuffing box system 510 to control production fluids outside, as well as a preventer 511 with O-ring seals, an a wedge preventer 512 to hold flexible tubing. At the wellhead 10, as part of the surface assembly 30, a connection and splicing means 15 is found; it consists of a flange (bridle) joining the surface assembly 30 with a production tubing 16. The connection and spicing means 15 allows holding and locking the production tubing 16. The production tubing 16 extends vertically downwards inside the casing 12, being production tubing 16 inside the casing 12 concentrically one to each other. Likewise, from surface equipment a flexible tubing 14 extends vertically downwards, from there it is projected again to continue its original direction downwards inside the well bore 10.

Flexible tubing 14 is located directly inside the production tubing 16, all along its length, being then the casing 12, production tubing 16 and flexible tubing 14 concentric to each other.

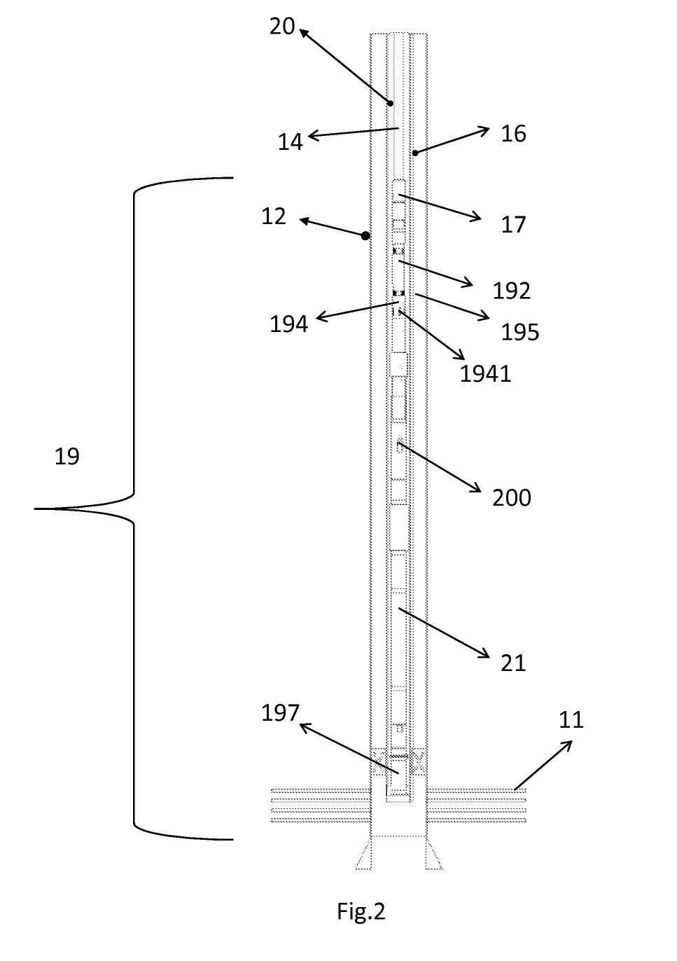

FIG. 2 shows a pump assembly 19 according to the present invention. Pump assembly 19 is fastened to the lower end of the flexible tubing 14, seated and anchored through a shoe connector 197 of the production tubing 16. Fastening between the pump assembly 19 and flexible tubing 14 is performed by a connector 17, link element located on the upper part of the pump assembly 19.

Likewise, other element included in the pump assembly 19 is the check valve 192 that prevents the extracted fluids to flow within the flexible tubing 14. In the pump assembly 19, the check valve 192 in turn is connected to a cleaning tool 194. The cleaning tool 194 includes on its surface a plurality of circulation ports 1941. These circulation ports 1941 consist of outlet holes for fluid and chemicals that will be pumped from the surface within the flexible tubing 14.

The cleaning tool 194 is the element from the pump assembly 19 where the pumped liquids flow from the surface. This cleaning tool 194 is coupled by a blind connection 195 directly to the plunger pump 21 of the pump assembly 19. The blind connection 195 is the only element of the pump assembly 19 where no fluid flows, whether from surface or directly extracted from the reservoir 11.

Blind connection 195 is thread connected to the plunger pump 21 that allows, through the production holes 200, the exit of production fluid from the reservoir 11, to be pumped through the annular space 20 to the surface.

Such as mentioned in the background chapter herein, one of the most frequent problems in the mechanical pumping system is sand drag from the reservoir 11 to the production tubing, directly affecting the pumping and transport system of crude oil or any hydrocarbon to the surface. Sand buildups in pumps or any element of the extraction system by mechanical pumping creates reduced efficiency and component wear, surpassing tolerances, therefore the well stops production.

Subsequently, the well extraction system is programmed for preventive and corrective maintenance, requiring disassembling the entire system for cleaning, changing pump, pipes, couples or other fixtures, which implies losses for stopping productive process and production times.

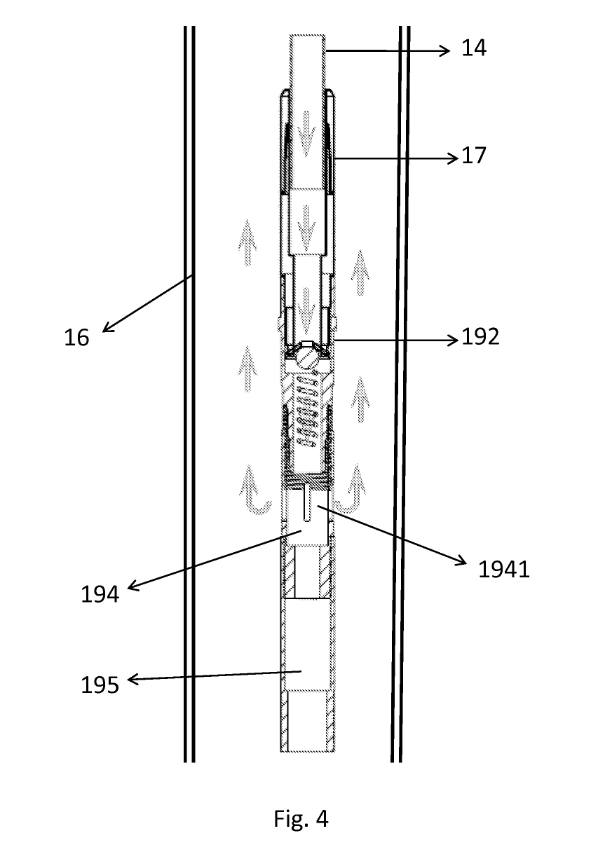

In contrast to all the above, with reference to FIG. 4, it shows circulation pattern of chemicals and fluids inside the artificial simultaneous production and maintenance system 100 assisted by mechanical pumping for fluid extraction. Fluids are pumped from the well surface by the surface equipment through the flexible tubing 14 until the cleaning tool 194, where the pumped fluid will exit through the circulation ports 1941. Such as we can observe from arrows representing fluid circulation in FIG. 4, the flow pumped inside the flexible tubing 14 returns again to the surface by flowing through the annular area 20 formed by both the flexible tubing 14 and production tubing 16. Variety of fluids to be pumped for well maintenance may be among others: necessary fluids for cleaning and desanding the well, chemicals to dissolve paraffin deposits, asphalts and scaling caused by carbonates, chemical fluids to modify several parameters of fluids coming from the reservoir as viscosity, density, etc.

Related to the above, the artificial simultaneous production and maintenance system assisted by mechanical pumping with flexible tubing for fluid extraction 100 allows continuous injection of viscosity reducer agents to improve production during pump 21 operation. It is important to mention that pumping any of the above chemicals can be made during oil or hydrocarbon extraction from reservoir 11. In this way maintenance to the artificial simultaneous production and maintenance system assisted by mechanical pumping with flexible tubing for fluid extraction 100 can be applied in well 10, by pumping chemicals from the surface equipment to clean, dissolve paraffin, asphalt deposits, descaling mineral salts and reduce viscosity. Chemicals flow inside the flexible tubing 14 not needing to extract the mechanical pumping apparel, including the pump, which implies important savings in dead time of equipment of well 10. Likewise it is possible an efficient sand and solid dragging to the surface making them flow by annular area 20 of the artificial simultaneous production and maintenance system assisted by mechanical pumping with flexible tubing for fluid extraction 100 of the present invention. All the above helps preventing failures in pumps in the artificial simultaneous production and maintenance system assisted by mechanical pumping with flexible tubing for fluid extraction 100 substantially increasing production time of well 10 before a major repair or maintenance.

It is important to point out that the artificial simultaneous production and maintenance system assisted by mechanical pumping with flexible tubing for fluid extraction 100 is a novel system requiring less installation and extraction time than any other conventional mechanical pumping system. For example, the flexible tubing string 14 can be designed according to deepness, pressure and expected loads during operation, varying diameter, wall thickness and stiffness of the material. Thus, we can preview the inner displacement in flexible tubing 14 for efficient cleaning and/or maintenance, and external displacement in flexible tubing 14 jointly with inner displacement of production tubing 16 to have annular area 20 for the optimum hydrocarbon production.

On the other hand, and in virtue that flexible tubing 14 bends or plies easily and is continuous, without connections or links, its installation and/or extraction is notably faster than a rod or coupling piping system.

Features of the flexible tubing 14 and equipment in general of the artificial simultaneous production and maintenance system make possible to maintain pressure control, permitting maneuvers during production in the well 10, not needing fluids to control the pressure.

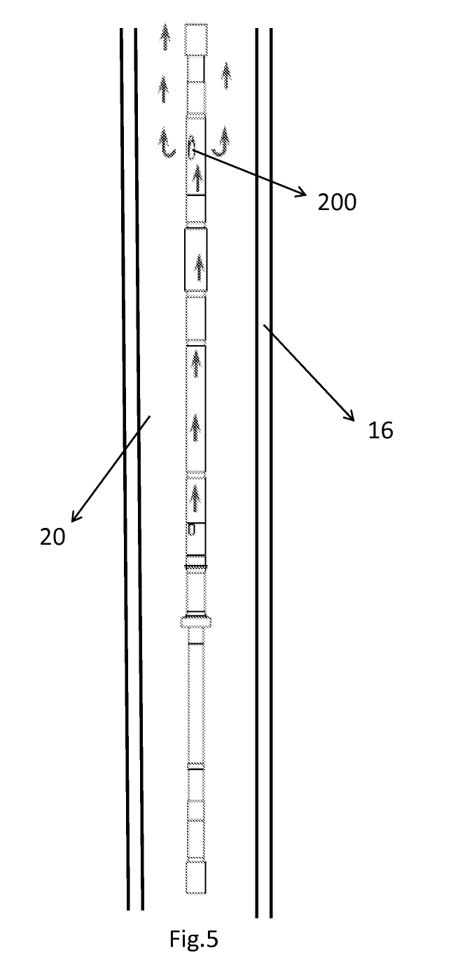

Related to production in well 10, reference is made to FIG. 5, which illustrates fluid circulation from reservoir 11 inside the artificial simultaneous production and maintenance system assisted by mechanical pumping with flexible tubing for fluid extraction 100. The fluid is pumped from the reservoir 11 to the oilwell surface through the pump assembly 19. Fluid production from reservoir 11 enters through the plunger pump 21, located on the lower portion of the pump assembly 19, and exits through production holes 200 towards the annular space 20 for subsequent flow to the surface through the annular space 20 formed between the interior of production tubing 16 and flexible tubing 14. Thus, there is a displacement of internal fluid through flexible tubing 14 inwards the well to make efficient cleaning and maintenance, and external displacement, out from the flexible tubing 14, to maintain an optimum annular space 20 for hydrocarbon production.

The artificial simultaneous production and maintenance system assisted by mechanical pumping for fluid extraction 100 including a flexible tubing 14 substantially reduces maintenance costs in the well 10, due to easiness to pump chemicals and reduce frequency of interventions to repair the well. With the artificial simultaneous production and maintenance system assisted by mechanical pumping with flexible tubing for fluid extraction_100, suspension of operation times of the well for cleaning and desanding are very reduced, because it is possible to add chemicals, like any of those herein mentioned above, during functioning of mechanical pumping; allowing thus optimization of production of well 10, and consequently saving costs when operating the well.

Likewise evidently depending on the deepness or characteristics of the well 10, the reservoir capacity, type of hydrocarbon extracted and/or type of oil field where the well 10 is located, the artificial simultaneous production and maintenance system assisted by mechanical pumping with flexible tubing for fluid extraction 100 of the present invention could vary in length, thickness and/or capacity of each element conforming the artificial simultaneous production and maintenance system assisted by mechanical pumping with flexible tubing for fluid extraction 100.

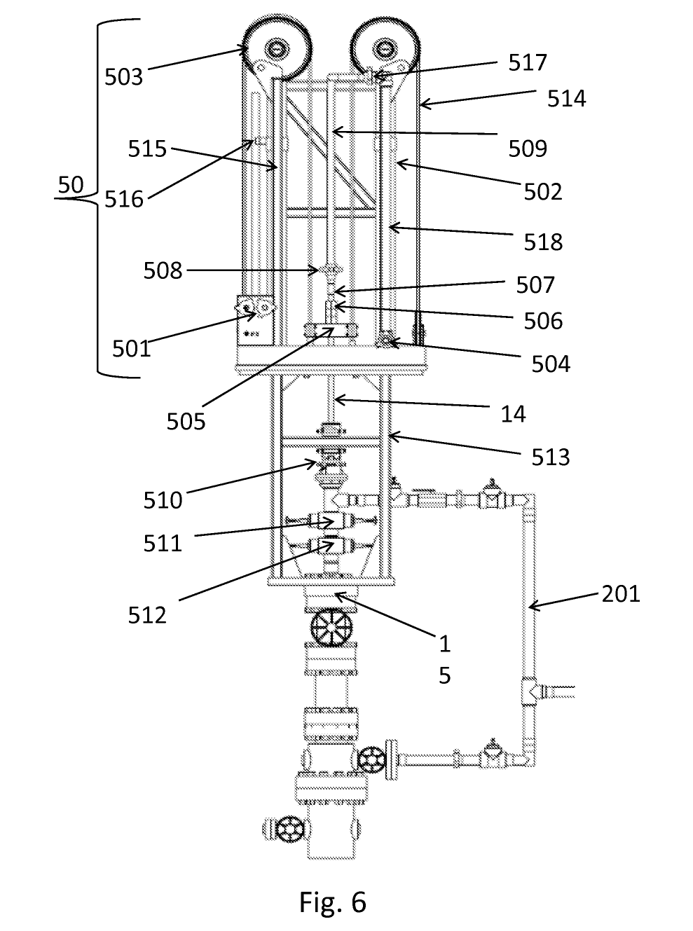

Finally, related to functioning of the hydraulic drive head, FIG. 6 shows the purpose for this head, which is to transfer the mechanical movement produced by an hydraulic power unit to the flexible tubing 14 to have an ascending and descending movement while the production tubing remains static inside the well. At the same time it is used to support all the weight of the flexible tubing 14 and the bottom assembly 19 shown in FIG. 2.

Ascending movement produced by the hydraulic drive head 50 is originated by hydraulic flow received from a power unit not shown in the figures. Hydraulic flow is received through hydraulic connections 501; said hydraulic flow extends the hydraulic pistons 502 lengthwise making the steel cables 514 to go through a pulley set 503 and lift a guide car 505, which in turn lifts the flexible tubing 14; this later is fastened to the guide car by a clamp set 506.

Descending movement produced by the hydraulic drive head 50 is originated by emptying the hydraulic fluid of hydraulic pistons 502 in a controlled way by the same hydraulic power unit. This movement is performed in reverse to the ascending movement previously described.

Another function of the hydraulic head 50 is to permit introduction of fluid or chemical to the well by the flexible tubing 14. This happens by pumping the fluids or chemicals through a pumping connection 504 known as type 1502, the fluid is transferred to a fixed metal pipe 518 fastened to the metallic structure 515. This pipe is connected to a flexible hose by a stationary hydraulic connector 517 and the other end of the hose 509 is connected to the flexible tubing 14 by a traveling hydraulic connector 508 and a high pressure connector 507, and signaling as a basic element the discharge tubing 201, where the final product circulates (derived from the flow obtained in the well).

From the above it is appreciated that, even though specific embodiments of the invention have been described herein for illustration purposes only, several modifications can be made without affecting the scope of the invention. Therefore, the invention is not limited except by the appended claims.

1. An artificial simultaneous production and maintenance system assisted by mechanical pumping with flexible tubing for fluid extraction, comprising: a reservoir, a well, a shoe connector, a cleaning tool, a blind connection, production holes, an annular space, circulation ports, a stuffing box system, an O-ring preventer, a wedge preventer, a check valve, a plunger pump, a surface assembly, a sub-base, a hydraulic drive head, a production tubing, a casing and a flexible tubing, the hydraulic drive head supports the weight of the flexible tubing, which permits circulation of fluid from the surface to downbore, in addition, the stuffing box controls production fluids to the exterior, the wedge preventer to fasten and a connection and splicing means; from the surface assembly the flexible tubing extends vertically downwards, fastened in the connection and splicing means, from there it projects itself again to continue its original direction downwards inside the well, which includes the production tubing and casing;
flexible tubing located inside the production tubing all along its length, being the casing, the production tubing and the flexible tubing concentrically one inside the other; and a pump assembly including a check valve, a cleaning tool and a plunger pump.

2. The artificial simultaneous production and maintenance system assisted by mechanical pumping with flexible tubing for fluid extraction, according to claim 1, wherein the pump assembly is fastened to the lower end of the flexible tubing by a connector and anchored at the lower end by a shoe connector inside the production tubing or casing.

3. The artificial simultaneous production and maintenance system assisted by mechanical pumping with flexible tubing for fluid extraction, according to claim 1, wherein the cleaning tool includes on its surface a plurality of circulation ports.

4. The artificial production and maintenance system assisted by mechanical pumping with flexible tubing for fluid extraction, according to claim 3, wherein the circulation ports consist of exit holes for chemicals and fluids pumped through the flexible tubing from the surface.

5. The artificial simultaneous production and maintenance system assisted by mechanical pumping with flexible tubing for fluid extraction, according to claim 4, wherein the flow of chemicals or fluids pumped inside the flexible tubing return again to the surface, flowing through the annular area, which is formed by the flexible tubing and production tubing or casing.

6. The artificial simultaneous production and maintenance system assisted by mechanical pumping with flexible tubing for fluid extraction, according to claim 1, wherein the cleaning tool is coupled by a blind connection directly to the plunger pump inside the pump assembly.

7. The artificial simultaneous production and maintenance system assisted by mechanical pumping with flexible tubing for fluid extraction, according to claim 6, wherein the blind connection is the element of the pump assembly where there is no fluid flow, either from the surface or directly extracted from the reservoir.

8. The artificial simultaneous production and maintenance system assisted by mechanical pumping with flexible tubing for fluid extraction, according to claim 6, wherein the blind connection is connected by thread with the plunger pump.

9. The artificial simultaneous production and maintenance system assisted by mechanical pumping with flexible tubing for fluid extraction, according to claim 1, wherein the plunger pump includes production holes that allow the exit of the flow coming from the reservoir to be pumped to the surface.

10. The artificial simultaneous production and maintenance system assisted by mechanical pumping with flexible tubing for fluid extraction, according to claim 1, wherein the flexible tubing is located inside the production tubing concentrically all along its length, forming an annular area where the fluid coming from the production holes flows.

11. A method to install the artificial simultaneous production and maintenance system assisted by mechanical pumping with flexible tubing for fluid extraction, wherein the method comprises the following steps:
A) Introducing a subsurface pump hauled by a flexible tubing string to the bottom of the well;
B) verifying the pump anchorage in its seating nipple or anchor (tubing in);
C) performing a cycling system test through the injecting head to verify the proper weight and strokes;
D) actuating the fixed preventers (O-rings and wedges) and making a cut to the flexible tubing;
E) installing the reciprocating mechanic or hydraulic surface equipment of the flexible tubing and surface connection of circulation in the flexible tubing and release preventers;
F) initiating reciprocating movement of the entire system;
G) making a connection on the circulation line joined to the flexible tubing to make continuous or intermittent pumping;
H) maintaining the reciprocating pump function for the well production together with the item G;
I) in case of load increase because of material dragging, making circulation pumping to do the cleaning, and if the problem persists, proceed to the system recovery;
J) disconnecting the flexible tubing from its respective circulation system and remove the surface mechanic or hydraulic equipment;
K) connecting the flexible tubing to flexible tubing equipment to recover the T.T. string and extract the pump to the surface;
L) extracting the bottom pump and cleaning the well to, if needed, intervene in the repair; and
M) repeating the installing operation of a repaired system.
